(19) United States
(12) Patent Application Publication
(10) Pub. No.: US 2022/0215656 A1
(43) Pub. Date: Jul. 7, 2022

(54) METHOD, APPARATUS, DEVICE FOR IMAGE PROCESSING, AND STORAGE MEDIUM

(71) Applicant: BEIJING SENSETIME TECHNOLOGY DEVELOPMENT CO., LTD., Beijing (CN)

(72) Inventors: Runmin DONG, Beijing (CN); Cong LI, Beijing (CN)

(21) Appl. No.: 17/701,812

(22) Filed: Mar. 23, 2022

Related U.S. Application Data
(63) Continuation of application No. PCT/CN2020/115423, filed on Sep. 15, 2020.

(30) Foreign Application Priority Data
Oct. 22, 2019 (CN) 201911008506.6

(51) Int. Cl. G06V 10/82; G06V 10/764

(52) U.S. Cl. CPC G06V 10/82; G06V 10/764

(57) ABSTRACT

In embodiments of the disclosure, provided is a method for image processing, including: acquiring a first target result from a classification result set, wherein the classification result set is obtained by a first neural network through processing a to-be-processed image, and includes classification results each corresponding to a respective one of a plurality of land cover classes; adjusting the first target result to obtain a second target result; and obtaining an image recognition result according to the second target result and the classification results in the classification result set except the first target result.

### CROSS-REFERENCE TO RELATED APPLICATIONS

This is a continuation of International Application No. PCT/CN2020/115423, filed on Sep. 15, 2020, which is based upon and claims priority to Chinese Patent Application No. 201911008506.6, filed on Oct. 22, 2019. The contents of International Application No. PCT/CN2020/115423 and Chinese Patent Application No. 201911008506.6 are incorporated herein by reference in their entireties.

### BACKGROUND

For great influence of agricultural expansion, urbanization, climate changes and the like on global food security, biodiversity, water resources, environment and human health, it is quite important to make a land cover map. In the related art, in a process of classifying a high-resolution image by a conventional neural network, detail features of the image are ignored, resulting in a classification result not accurate enough. Moreover, an image processing algorithm is relatively complex, resulting in low efficiency in making the land cover map and low accuracy of the obtained land cover map.

### SUMMARY

Embodiments of the disclosure relate to the fields of machine learning and deep learning, and relate to, but not limited to, a method, apparatus and device for image processing, and a storage medium.

In embodiments of the disclosure, provided is a method for image processing, including: acquiring a first target result from a classification result set, wherein the classification result set is obtained by a first neural network through processing a to-be-processed image, and includes classification results each corresponding to a respective one of a plurality of land cover classes; adjusting the first target result to obtain a second target result; and obtaining an image recognition result according to the second target result and the classification results in the classification result set except the first target result.

In embodiments of the disclosure, provided is an apparatus for image processing, including: an acquisition module, configured to acquire a first target result from a classification result set, wherein the classification result set is obtained by a first neural network through processing a to-be-processed image, and includes classification results each corresponding to a respective one of a plurality of land cover classes; and a processing module, configured to adjust the first target result to obtain a second target result, wherein the processing module is further configured to obtain an image recognition result according to the second target result and the classification results in the classification result set except the first target result.

In embodiments of the disclosure, provided is a non-transitory computer storage medium having stored thereon computer-executable instructions that, when being executed, implement following actions: acquiring a first target result from a classification result set, wherein the classification result set is obtained by a first neural network through processing a to-be-processed image, and includes classification results each corresponding to a respective one of a plurality of land cover classes; adjusting the first target result to obtain a second target result; and obtaining an image recognition result according to the second target result and the classification results in the classification result set except the first target result.

In embodiments of the disclosure, provided is a computer device, including a memory and a processor, wherein computer-executable instructions are stored in the memory, and the computer-executable instructions in the memory, when operated by the processor, cause the processor to : acquire a first target result from a classification result set, wherein the classification result set is obtained by a first neural network through processing a to-be-processed image, and includes classification results each corresponding to a respective one of a plurality of land cover classes; adjust the first target result to obtain a second target result; and obtain an image recognition result according to the second target result and the classification results in the classification result set except the first target result.

In embodiments of the disclosure, provided is a computer program, including computer-readable code that, when running in a device, causes a processor in the device to execute instructions configured to implement the method for image processing provided in embodiments of the disclosure.

It is to be understood that the above general description and the following detailed description are only exemplary and explanatory and not intended to limit the application.

### BRIEF DESCRIPTION OF THE DRAWINGS

The accompanying drawings, which are incorporated in and constitute a part of this specification, illustrate embodiments consistent with the application and, together with the specification, serve to describe the technical solutions of the application.

FIG. 1 illustrates a flowchart of an implementation of a method for image processing according to embodiments of the disclosure.

FIG. 2A illustrates a flowchart of another implementation of a method for image processing according to embodiments of the disclosure.

FIG. 2B illustrates a flowchart of yet another implementation of a method for image processing according to embodiments of the disclosure.

FIG. 3 illustrates a flowchart of a further implementation of a method for image processing according to embodiments of the disclosure.

FIG. 4 illustrates a structural diagram of a neural network according to embodiments of the disclosure.

FIG. 5 illustrates a structural diagram of composition of an apparatus for image processing according to embodiments of the disclosure.

FIG. 6 illustrates a structural diagram of a computer device according to embodiments of the disclosure.

### DETAILED DESCRIPTION

In order to make the purposes, technical solutions and advantages of the embodiments of the disclosure clearer, specific technical solutions of the disclosure will further be described below in combination with the drawings in the embodiments of the disclosure in detail. The following embodiments serve to describe the disclosure rather than limit the scope of the disclosure.

The technical solutions provided in the embodiments of the disclosure may be applied to using a small High-Resolution Net (HR-Net) to process a to-be-processed image with. The small HR-Net may be a neural network (i.e., a first neural network) obtained by pruning a network layer (for example, a convolution kernel in a convolution layer) in an original HR-Net (i.e., a second neural network) and includes simpler network layers (for example, fewer convolution kernels in convolution layers). During implementation, using the first neural network to process the to-be-processed image may keep a high resolution of the to-be-processed image. Moreover, since the network layers in the first neural network are simplified, processing actions may further be simplified, and the processing may be accelerated.

In some embodiments, the second neural network and the first neural network may be any neural networks with a function of keeping the resolution of the to-be-processed image input into the networks, and no limitation is set in the embodiments of the disclosure.

A method, apparatus and device for image processing, and a storage medium are provided in the embodiments of the disclosure. In the method, a first target result is acquired from a classification result set firstly. The classification result set is obtained by a first neural network through processing a to-be-processed image, and includes classification results each corresponding to a respective one of a plurality of land cover classes. Then, the first target result is adjusted to obtain a second target result. Finally, an image recognition result is obtained according to the second target result or according to the second target result and the classification results in the classification result set except the first target result. In such a manner, some or all results in the classification result set are adjusted, namely the determined first target result is adjusted, to obtain the second target result, and then the image recognition result is obtained according to all second target results obtained after the adjustment and an unadjusted classification result in the classification result set. The unadjusted classification result may or may not exist. Since the recognizability of the second target result obtained after the adjustment is higher than that of the first target result before adjustment, a more accurate image recognition result may be obtained through the implementation provided in the embodiments of the disclosure.

An application process of the first neural network will be described below in detail.

A method is applied to a computer device. In some embodiments, a function realized by the method may be realized by a processor in the computer device calling program code. The program code may be stored in a computer storage medium.

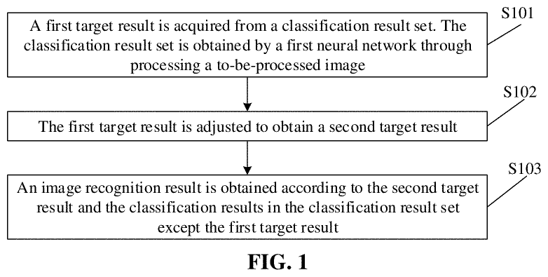

In embodiments of the disclosure, a method for image processing is provided. FIG. 1 illustrates a flowchart of an implementation of a method for image processing according to embodiments of the disclosure. As illustrated in FIG. 1, the method may include the following actions S101 to S103.

In S101, a first target result is acquired from a classification result set. The classification result set is obtained by a first neural network through processing a to-be-processed image.

The to-be-processed image may be such as a static image, a remote sensing image or video frame image with any size and containing land cover conditions. The to-be-processed image may be an image for object detection or recognition, an image for foreground/background segmentation, an image for object tracking, or the like.

In some embodiments, the first neural network may be obtained based on a trained second neural network. A complexity of the second neural network is higher than a complexity of the first neural network. Before S101, that is, before the first target result is acquired, the method further includes: the to-be-processed image is processed by a first convolution layer in the first neural network to obtain a first intermediate result; and the first intermediate result and the to-be-processed image are processed by a second convolution layer in the first neural network to obtain a second intermediate result, and the second intermediate result and the to-be-processed image are processed as input of a next convolution layer in the first neural network until the classification result set is obtained. That is, firstly, the to-be-processed image is input into the first neural network and is processed by an i^{th} convolution layer in the first neural network to obtain an output result. Then, the output result and the to-be-processed image are input into an (i+1)^{th} convolution layer to obtain the classification result set. i is an integer greater than or equal to 1. For example, a network layer (for example, a convolution kernel in a convolution layer) in the second neural network may be pruned to obtain the first neural network containing simpler network layers (for example, fewer convolution kernels in convolution layers). In such a manner, the first neural network obtained may also have a property of the second neural network, namely both the first neural network and the second neural network have a function of keeping the resolution of the input image. Moreover, since the first neural network is obtained by pruning network layers in the second neural network, the complexity of the second neural network is usually higher than the complexity of the first neural network.

After the first neural network is obtained, the to-be-processed image may be processed by the first neural network to obtain the classification result set of the to-be-processed image.

For example, a group of sample sub-images may be acquired. The group of sample sub-images are acquired in a same region at different time nodes. Then pixel channels in all sample sub-images in the group of sample sub-images are combined to obtain a sample image corresponding to the same region. The pixel channels may be combined in the following way: concatenating all sample sub-images. Picture content in multiple sample sub-images to be concatenated to form the sample image correspond to different time nodes.

In some embodiments, the to-be-processed image may be a sample image. In such case, the to-be-processed image may include images of the same region at multiple time nodes. The images of the same region at the multiple time nodes may serve as sample sub-images and may be processed through channel combination, and a processing result obtained through the processing is taken as the sample image to be input into a first neural network model.

In some embodiments, the image may be in a Tag Image File Format (TIFF), and each image contains four channels, specifically RGBN, i.e., red (R), green (G), blue (B) and Near Infrared (NIR). Images input into the first neural network are acquired at two different time nodes. With summer images as an example, each input summer image corresponds to a respective winter image. When the summer image is input into the first neural network, the corresponding winter image is integrated with the summer image, namely the two images are concatenated to form one image. For example, the summer image (four channel values of the summer image are R₁G₁B₁N₁ respectively) and the corresponding winter image (four channel values of the winter image are R₂G₂B₂N₂ respectively) both have values of the four channels RGBN. Concatenating the two images refers to concatenating the channel values of the two images, namely channel values of the concatenated image are R₁G₁B₁N₁R₂G₂B₂N₂. Thus, an image with 8 channels is obtained by combining pixel channels of two images each having 4 channels.

It is to be noted that, in the embodiments of the disclosure, the number of channels in images for implementing pixel channel combination is not limited and specific embodiments may refer to the content listed above. Of course, during image concatenation, what are concatenated may also be images acquired at three different time nodes or even more time nodes, and/or a specific manner of concatenation may include but not limited to that the channel values are concatenated together in the above embodiment, limitations are not set herein.

In a process of determining a sample image, one group of sample sub-images are acquired in multiple regions in summer, and the other group of sample sub-images are acquired in the same multiple regions in winter. After channel combination is performed on the two groups of sample sub-images, a group of sample images corresponding to the multiple regions respectively can be obtained. Each sample image may present content of the sample sub-images acquired at the different time nodes respectively. For example, each sample image may present content of the sample sub-images acquired at any time nodes in the two seasons of summer and winter respectively. A specific manner of channel combination may refer to the above description and will not be described herein again.

In the embodiments of the disclosure, the images acquired in winter and the images acquired in summer are combined in channels to obtain the group of sample images corresponding to the multiple regions. Each sample image may present the content of the sample sub-images acquired at any time nodes in the two seasons of summer and winter respectively. Since a summer sample image is favorable for recognition of various plants and a winter sample image contains less cloud cover, the advantages of the images corresponding to the two seasons during processing are effectively utilized during image processing. Thus, the problem of cloud cover existing in a summer sample image is further effectively solved in map making, and the robustness of the network is improved.

In the embodiments of the disclosure, the classification result set may include classification results each corresponding to a respective one of a plurality of land cover classes. For example, the classification result corresponding to a certain land cover class may include probability information that picture content in the to-be-processed image belongs to the land cover class. The probability information may be understood as a probability map corresponding to the class, a confidence map corresponding to the class, or the like, no limitation is set in the embodiments of the disclosure.

At least two sample images are processed by the first neural network to obtain a classification result set, and a first target result is selected from the classification result set. The at least two sample images are acquired at different time nodes, and are labelled sample images. The different time nodes may be selected as time nodes in different seasons, or may be selected as time nodes in different periods in the same season. Cloud cover conditions in the same scene are different in different seasons, and are different under different weather conditions in the same season.

Therefore, the abovementioned process may be understood as follows: the labelled sample images are processed by the first neural network to obtain the classification result set, and the first target result is selected from the classification result set. In such case, the labelled sample images are taken as input images of the first neural network, so that expensive and time-consuming data interpretation is not needed. Moreover, sample images acquired at two time nodes are input into the first neural network to obtain the classification result set. Since the summer sample image is favorable for recognition of various plants and the winter sample image contains less cloud cover, the problem of cloud cover existing in the summer sample image may be effectively solved in map making, and the robustness of the network is improved.

In S102, the first target result is adjusted to obtain a second target result.

In some embodiments, the first target result may be adjusted to obtain the second target result. A manner of adjustment may specifically be implemented as: adjusting a recognition parameter of the first target result to obtain the second target result. A recognizability of the second target result obtained after the adjustment is usually higher than a recognizability of the first target result. For example, a recognition parameter may be a parameter, such as contrast, that influences the recognizability of a target result (for example, the first target result or the second target result).

In an example, the contrast of the first target result is adjusted to obtain the second target result. For example, histogram equalization is performed on the first target result to obtain the second target result; or, gamma transformation is performed on the first target result to obtain the second target result; or, the first target result is clustered to obtain the second target result; or, adaptive grayscale histogram equalization is performed on the first target result to obtain the second target result. It is to be noted that an implementation of obtaining the second target result may include but not limited to those listed above and may specifically be a single implementation or a combination of multiple implementations, etc., and no limitation is set here.

In some embodiments, the first target result is a probability map corresponding to a specific class, and histogram equalization is performed on the probability map corresponding to the specific class to enhance the contrast of the probability map to obtain the second target result.

It can be understood that, by means of histogram equalization, the histogram of the first target result may be transformed into a uniformly distributed (equalized) second target result by changing a grayscale of the image in the histogram of the first target result. For example, the grayscale of a pixel corresponding to a higher probability in the histogram of the first target result is increased, and the grayscale of a pixel corresponding to a lower probability in the histogram is decreased. As such, a dynamic range of a probability value difference among pixels is enlarged, so that an effect of enhancing an overall contrast of the second target result is achieved. In other words, the basic principle of histogram equalization is that: probability values corresponding to a larger number of pixels in the first target result are widened while probability values corresponding to a smaller number of pixels are merged, thereby increasing the contrast, so as to enable the probability map clear and achieve a purpose of enhancement, thus improving the recognizability of the obtained second target result. For example, the specific class is an impervious layer class. In such case, the first target result may be a probability map formed based on probabilities that all pixels in the sample image may belong to the impervious layer class. Histogram equalization is performed on the probability map corresponding to the impervious layer class, so that roads, buildings, or the like in the probability map are enhanced, so that the impervious layer class can be recognized better.

In S103, an image recognition result is obtained according to the classification results in the classification result set except the first target result and the second target result.

The image recognition result includes a created land cover map. For example, the land cover map is created according to the second target result and the classification results in the classification result set except the first target result. A maximum value among the classification results corresponding to all the land cover classes is determined through the second target result and the classification results in the classification result set except the first target result. In such a manner, a most possible class of each pixel in the sample image is determined. Based on this, the land cover map representing land cover conditions is created.

In the embodiments of the disclosure, obtaining the image recognition result according to the second target result may be understood as that a set of “the classification results except the first target result” is empty, namely each classification result in the classification result set is determined as the first target result. Then, the image recognition result is subsequently determined by use of second target results obtained by processing all the first target results.

It is to be noted that, considering all or part of the first target result may be adjusted during practical operation, corresponding implementation means for processing may be selected based on different implementation conditions in a process of obtaining the image recognition result. That is, in the case where all of the first target result is adjusted, the image recognition result is obtained according to all of the obtained second target result; or in the case where part of the first target result is adjusted, the image recognition result is obtained according to all of the obtained second target result and all of the first target result that is not used to obtain the second target result.

In the embodiments of the disclosure, a labelled sample image may be classified by the first neural network with the function of keeping the resolution of the sample image input into the first neural network, and the first target result is selected from the classification result set. Then, the contrast of the first target result is adjusted to improve the recognizability of the first target result. The land cover map is created based on the second target result obtained after the adjustment and the other classification results in the classification result set. In such a manner, the to-be-processed image is classified by the high-resolution first neural network, and the contrast of the target result is optimized, so that more feature information of the to-be-processed image may be retained to facilitate improving the accuracy of the classification results, and the accuracy of creating the land cover map is further improved.

In some embodiments, a network layer (for example, a convolution kernel in a convolution layer) in the second neural network may be pruned to obtain the first neural network containing simpler network layers (for example, fewer convolution kernels in convolution layers). During implementation, processing the to-be-processed image by the first neural network may keep a high resolution of the to-be-processed image. Moreover, since the network layers are simplified, processing actions may further be simplified, and a processing procedure may be accelerated. In some embodiments, the number of convolution kernels in the first neural network is smaller than the number of convolution kernels in the second neural network, and the second neural network is a trained neural network. In some embodiments, the second neural network contains 30 convolution kernels, and the first neural network is obtained by deleting 12 convolution kernels from the second neural network.

In some embodiments, the first neural network may be obtained in the following implementation.

Action 1, a set of 2-norm sums corresponding to convolution kernels in at least one layer in the second neural network is determined.

A 2-norm sum corresponding to each of the convolution kernels includes a sum of 2-norms, each between a convolution kernel parameter of the convolution kernel and a convolution kernel parameter of a respective another convolution kernel, and the respective another convolution kernel is in a same layer in the second neural network as the convolution kernel. For example, a sum of 2-norms each between a parameter of an i^{th} convolution kernel in an I^{th} layer in the second neural network and a parameter of a respective another convolution kernel in the I^{th} layer is determined. In such a manner, a 2-norm sum corresponding to each convolution kernel is determined. I and i are both integers greater than or equal to 1. The second neural network is a trained neural network and has the function of keeping the resolution of the input image. Alternatively, the second neural network may be understood as an HR-Net. That is to say, an original resolution of the to-be-processed image may be kept while semantic information of the input to-be-processed image is extracted, thereby providing more feature information for classifying the to-be-processed image, so as to improve the accuracy of classification.

The first neural network may be obtained by deleting a convolution kernel meeting a condition from the second neural network. Both the first neural network and the second neural network have the function of keeping the resolution of the input to-be-processed image. After the network layer (for example, the convolution kernel in the convolution layer) in the second neural network with the function of keeping the resolution of the input image is pruned, the obtained first neural network contains simpler network layers (for example, fewer convolution kernels in convolution layers). Therefore, the number of layers or convolution kernels in the obtained first neural network is smaller than that of the second neural network, namely the complexity of the first neural network is lower than the complexity of the second neural network. In some embodiments, the number of convolution kernels contained in the first neural network is smaller than the number of convolution kernels contained in the second neural network, and the second neural network is a trained neural network. In some embodiments, the second neural network contains 30 convolution kernels, and the first neural network is obtained by deleting 12 convolution kernels from the second neural network.

Action 2, a target 2-norm sum smaller than a preset threshold is determined in the set of 2-norm sums.

Generally, the set of 2-norm sums may include multiple 2-norm sums, and usually includes multiple target 2-norm sums smaller than the preset threshold.

Action 3, a convolution kernel parameter of a convolution kernel corresponding to the target 2-norm sum is adjusted to obtain the first neural network. In some embodiments, for the i^{th} convolution kernel in the I^{th} layer, after it is determined that a sum of 2-norms each between the convolution kernel parameter of the i^{th} convolution kernel and a convolution kernel parameter of a respective another convolution kernel in the I^{th} layer is smaller than the preset threshold, the convolution kernel parameter of the i^{th} convolution kernel may be set to be 0, or the i^{th} convolution kernel may be directly deleted. If the sum of 2-norms is smaller than the preset threshold, it indicates that the i^{th} convolution kernel is relatively similar to the other convolution kernels in the same layer and thus may be replaced with the other convolution kernels. Therefore, deleting the i^{th} convolution kernel has slight influence on the performance of the first neural network, and the influence is negligible.

In some embodiments, the action 3 above may be implemented through the following process. Firstly, the convolution kernel parameter corresponding to the target 2-norm sum is set to be 0, to obtain a second neural network parameter-adjusted. Then, the to-be-processed image is sampled and a loss function of the parameter-adjusted second neural network is obtained, to continue training the parameter-adjusted second neural network. Next, a sum of 2-norms is determined for each convolution kernel parameter in the trained parameter-adjusted second neural network, to obtain another 2-norm sum set. Each of the 2-norms is between the convolution kernel parameter and a respective another convolution kernel parameter in a layer that the convolution kernel parameter belongs to. Later on, another target 2-norm sum smaller than the preset threshold is determined in the another 2-norm sum set. Finally, a convolution kernel corresponding to the another target 2-norm sum is deleted to obtain the first neural network. In such a manner, a convolution kernel relatively similar to another convolution kernel in the second neural network is deleted to obtain the first neural network containing fewer parameters. Therefore, processing the to-be-processed image by the first neural network containing fewer parameters can increase a speed of processing the to-be-processed image.

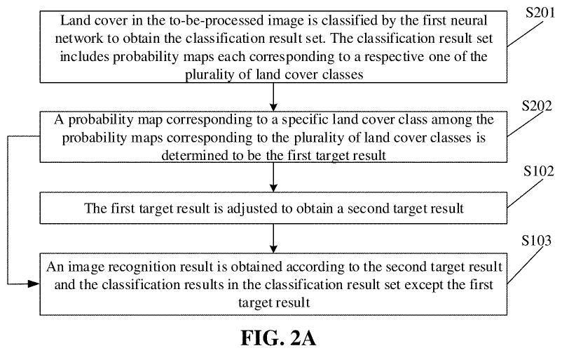

In some embodiments, in order to improve the accuracy of the acquired first target result, S101 may be implemented through the following S201 to S202. Referring to FIG. 2A, FIG. 2A illustrates a flowchart of another implementation of a method for image processing according to embodiments of the disclosure. The following description is made based on the actions in FIG. 1.

In S201, land cover in the to-be-processed image is classified by the first neural network to obtain the classification result set. The classification result set includes probability maps each corresponding to a respective one of the plurality of land cover classes.

The to-be-processed image is input into the first neural network. The first neural network performs land cover classification on picture content in the to-be-processed image, to determine which land cover class the picture content may belong to: the impervious layer class, an ice-snow class, a cultivated land class, or other classes. In some embodiments, S201 may be understood as follows: probability information that the land cover class of the picture content in the to-be-processed image is the impervious layer class, the ice-snow class and the cultivated land class is processed by the first neural network, to obtain a probability map that the land cover class of the picture content in the to-be-processed image is the impervious layer class, a probability map that the land cover class of the picture content in the to-be-processed image is the ice-snow class, and a probability map that the land cover class of the picture content in the to-be-processed image is the cultivated land class. The probability map corresponding to each land cover class may be understood as an intermediate parameter of a classification result.

In S202, a probability map corresponding to a specific land cover class among the probability maps corresponding to the plurality of land cover classes is determined to be the first target result.

The specific land cover class includes a land cover class corresponding to picture content of which a class recognizability is lower than a recognizability threshold. The specific land cover class is a class that is relatively difficult to recognize, for example, the impervious layer class. The probability map corresponding to the impervious layer class, i.e., the first target result, is selected from the probability maps corresponding to the plurality of land cover classes. When there may be a classification result that is not adjusted, in S102 and S103, the image recognition result is obtained according to all of the second target results obtained after the adjustment and the unadjusted classification result. Since the recognizability of the second target result obtained after the adjustment is higher than that of the first target result that is not adjusted, the accuracy of the image recognition result is improved.

In some embodiments, in order to improve the transferability of the first neural network, before S201, the method may further include the following process: instance normalization (IN) and batch normalization (BN) are successively performed on the to-be-processed image by the first neural network, to obtain a candidate image, and land cover corresponding to picture content in the candidate image is classified to obtain the probability maps corresponding to the plurality of land cover classes. For example, firstly, a first BN layer with a BN function in the first neural network is determined, and a BN layer that is the first to perform BN on the to-be-processed image in the first neural network is determined. Then, batch normalization in the BN layer is replaced with instance normalization. In some embodiments, after batch normalization in the BN layer is replaced with instance normalization, the layer has an instance normalization function and may perform instance normalization on the input to-be-processed image. As such, even if the input to-be-processed image is greatly different from another to-be-processed image, the distribution of the to-be-processed image per se may still be normalized. Thus, the transferability of the first neural network is improved.

It can be understood that batch normalization refers to normalizing each batch of data. During training, a certain batch of data {x1, x2, . . . , xn} may be normalized in any layer of the network. It is to be noted that, the data may be an input, or may be an output of a certain intermediate layer in the network. The essence of batch normalization is to update the magnitude of a variance and the location of a mean value by optimization, so that new distribution is more consistent with real distribution of the data, ensuring a nonlinear expression capability of a model.

Instance normalization may be considered as applying a batch normalization formula to each input data (also referred to as an instance) independently, as if the input characteristic was the only member in batch processing.

In some embodiments, the operation that the land cover corresponding to the picture content in the candidate image is classified to obtain the probability maps corresponding to the plurality of land cover classes may be implemented through the following actions.

Action 1, probability sets corresponding to all pixels in the candidate image are determined by the first neural network according to the plurality of land cover classes in a preset land cover class library.

A probability set corresponding to each pixel includes probabilities that the pixel belongs to the plurality of land cover classes respectively. The preset land cover class library may include multiple of the following 10 classes: the cultivated land class, a forest land class, a grassland class, a shrub land class, a wetland class, a water class, a tundra class, the impervious layer class, a bare land class and the ice-snow class, and may also include other classes different from the listed 10 classes. No limitation is set herein.

In some embodiments, firstly, a probability that a land cover class contained in a j^{th} pixel of the to-be-processed image is each of the preset land cover classes in a preset land cover class library is determined by the first neural network. Then, a probability set of the j^{th} pixel is obtained based on probabilities corresponding to all the preset land cover classes. For example, a land cover class contained in the j^{th} pixel of the to-be-processed image is determined by the first neural network obtained after the replacement, j being an integer greater than or equal to 1. Then, the probability that the land cover class contained in the j^{th} pixel is each of the preset land cover classes in the preset land cover class library is determined, to obtain the probability set corresponding to the j^{th} pixel. For example, probability that the land cover class contained in the j^{th} pixel is each of the 10 classes in the preset land cover class library is determined, to obtain a 10-dimensional probability value.

Action 2, the probability maps corresponding to the plurality of land cover classes are obtained according to probability sets corresponding to all pixels in the candidate image.

In some embodiments, firstly, the probability map corresponding to a same class is generated according to probabilities corresponding to the same class in the probability sets of multiple pixels in the candidate image. Then, the probability maps corresponding to the multiple land cover classes are obtained based on the probability map corresponding to each class. The probabilities corresponding to a same class are selected from the probability sets corresponding to all the pixels in the candidate image to generate the probability map corresponding to the same class. For example, the candidate image includes 100 pixels. The pixels are classified by the first neural network, to obtain a probability that a land cover class contained in each pixel is each preset land cover class in the preset land cover class library, namely 10 probabilities are obtained. Then, the probability corresponding to the cultivated land class is selected from the 10 probabilities corresponding to each pixel, to obtain a probability map corresponding to the cultivated land class. Next, the probability corresponding to the impervious layer class is selected from the 10 probabilities corresponding to each pixel, to obtain a probability map corresponding to the impervious layer class. Similar operations are executed to obtain the probability map corresponding to each land cover class in the preset land cover class library.

In some embodiments, in order to improve the accuracy of the created land cover map, S103 may be implemented through the following actions. Referring to FIG. 2B, FIG. 2B illustrates a flowchart of another implementation of a method for image processing according to embodiments of the disclosure. The following description is made based on the actions illustrated in FIG. 1.

In S221, a target classification result corresponding to each pixel in the to-be-processed image is determined according to the second target result and the classification results in the classification result set except the first target result.

A maximum value among the probabilities corresponding to the land cover classes that each pixel in the to-be-processed image belongs to is determined according to the second target result and the classification results in the classification result set except the first target result.

In some embodiments, there are 10 land cover classes. If the classification result set includes the probability maps corresponding to the multiple land cover classes, the first target result is the probability map corresponding to the impervious layer class among the probability maps corresponding to the multiple land cover classes, and the second target result is obtained by performing region adaptive histogram equalization on the probability map corresponding to the impervious layer class. S221 may be understood as follows: a maximum probability value corresponding to the land cover classes that each pixel in the to-be-processed image belongs to is determined according to the probability map, having subjected to the histogram equalization, corresponding to the impervious layer class and the probability maps corresponding to the other 9 classes among the probability maps corresponding to the multiple land cover classes. That is, if the preset land cover class library includes 10 classes, each pixel corresponds to 10 probabilities (i.e., probabilities that each pixel may belong to the 10 classes contained in the preset land cover class library respectively). For example, a maximum probability value is selected from 10 probabilities corresponding to an i^{th} pixel, and a target class corresponding to the maximum probability value is the class that the i^{th} pixel is most likely to belong to. In such a manner, target classes that all pixel are most likely to belong to are sequentially determined.

In S222, the image recognition result is obtained according to a land cover class corresponding to the target classification result.

In some embodiments, for the i^{th} pixel, the target class corresponding to the maximum probability value corresponding to the i^{th} pixel is determined. For example, if a probability value corresponding to the ice-snow class is the maximum among the 10 probabilities of the i^{th} pixel, it indicates that the pixel is most likely to belong to the ice-snow class. In some embodiments, after the target class of each pixel in the to-be-processed image is determined, namely after the class that each pixel is most likely to belong to is determined, the most possible land cover class at a position of the pixel is determined. Therefore, a land cover map may be created on the basis that the land cover class of each pixel in the to-be-processed image is determined.

In the embodiments of the disclosure, the land cover class that each pixel in the to-be-processed image is most likely to belong to is determined firstly, and then, based on this, the land cover map is created. Thus, the accuracy of the created land cover map is improved.

Land cover information may be used to analyze great influence of agricultural expansion, urbanization, climate changes and the like on global food security, biodiversity, water resources, environmental contamination and human health. However, manual or semi-manual land cover interpretation of a satellite image requires high costs and consumes long time, resulting in that making a large-scale land cover map requires high costs and a long period. For example, labelling data of about 160,000 square kilometers of the Chesapeake Bay drainage basin in northeast USA cost 10 months and 1 million dollars. Moreover, public land cover datasets are limited and can hardly support making a national and even global land cover map. Due to the limitation of data labelling, a model obtained in a limited scenario is limited in terms of the robustness and the generalization to a certain extent and can hardly be applied to a large-scale scenario directly. Due to that higher resolutions are needed in making land cover maps, which directly results in sharp increase in the amount of satellite image data, higher efficiency is required in making a land cover map based on a high-resolution satellite image, which increases the overhead of model prediction inevitably.

For solving the foregoing problem, a method for image processing is provided in the embodiments of the disclosure. At first, labelled sample images are used as data labels, and images with higher quality are screened out for use in model training, so that high-cost and time-consuming data interpretation processes are reduced. Then, for a remote sensing application scenario of land cover, an HR-Net is used to improve a result of land cover map making In addition, adaptive histogram equalization is performed to optimize discontinuous road target prediction results in impervious layers and parts in the impervious layers where urban buildings are connected into a piece without details. Finally, model channels are pruned to improve the efficiency of making a land cover map with a complex model and also improve the accuracy of the result.

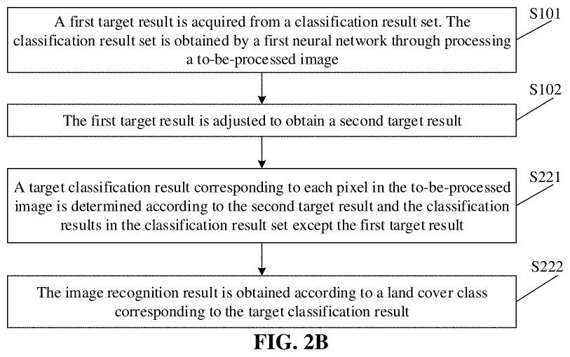

FIG. 3 illustrates a flowchart of yet another implementation of a method for image processing according to embodiments of the disclosure. As illustrated in FIG. 3, the method may be implemented through the following actions.

Action 1, network segmentation and training are performed in a scenario where a sample image is a remote sensing image.

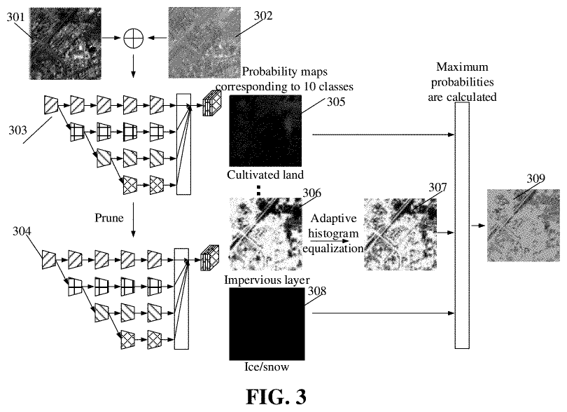

In some embodiments, firstly, since a high-resolution feature is needed in extracting semantic information of a sample image in a remote sensing image, an HR-Net is selected to extract the semantic information of the sample image in the remote sensing image in the embodiments of the disclosure. As illustrated in FIG. 4, FIG. 4 illustrates a structural diagram of a neural network according to embodiments of the disclosure. The HR-Net corresponds to a first neural network 401 including four stages, i.e., stages 402 to 405.

The stage 402 serves as an input end, receives the sample image in the input remote sensing image, keeps a resolution of the input image and output the sample image to the stage 403.

In the stage 403, a first layer 431 continues keeping the resolution of the input image, and a second layer 432 compresses the resolution of the input image. The resolution of the image is compressed to ½ of the original resolution. The input image with the resolution kept by the first layer and the compressed image are input into the stage 404.

In the stage 404, a first layer 441 continues keeping the resolution of the input image, a second layer 442 keeps the resolution of the compressed input image from the stage 403, and a third layer 443 compresses the compressed input image from the stage 403 for a second time. The input image, the compressed image from the stage 403, and the image that has been compressed for the second time by the third layer 443 are input into the stage 405.

In the stage 405, a first layer 451 continues keeping the resolution of the input image, and a second layer 452 keeps the resolution of the compressed image from the stage 403. A third layer 453 keeps the resolution of the image that has been compressed for the second time by the third layer 443 in the stage 404. A fourth layer 454 further compresses the resolution of the image that has been compressed for the second time by the third layer 443 in the stage 404. In such a manner, semantic information of an input image can be extracted by compressing the resolution of the input image for many times. Moreover, by keeping images under various resolutions, more feature information may be maintained (for example, a texture feature, which enables a segmentation result to be more exquisite, and facilitates feature extraction of a deep network), and the accuracy of the made land cover map is further improved.

Secondly, sample images of two temporals (for example, summer and winter) in the remote sensing images are taken as inputs of the network. The summer image is favorable for recognition of various plants, and the winter image contains less cloud cover, so that the problem of cloud cover existing in the summer image may be effectively solved in map making, and the robustness of the network is further improved. As illustrated in FIG. 3, channels of an image 301 and an image 302 are combined in a data layer, and the combined image is input into the HR-Net, i.e., an initial network 303 (corresponding to the second neural network in the above embodiment). As such, by combining the images of the two temporals, a prediction result of the network may be more accurate. In the embodiments of the disclosure, a labelled land cover image is used as a data label of the sample image, so that high-cost and time-consuming data interpretation processes may be reduced.

Next, a first batch normalization (BN) layer in the network is replaced with an instance normalization layer, and a normalization policy is used for complex spatial distribution data to improve the generalization capability of a model. As such, by replacing the first BN layer in the network with the IN layer, the transferability of the network may be improved. Moreover, for satellite images obtained by different sensors, the prediction result may be effectively promoted by processing the images through IN.

Finally, a proportion of an impervious layer class in a loss function is increased. In such a manner, for the impervious layer class (for example, roads and buildings) with a small proportion and containing complex targets, the proportion of the class in the loss function is increased, so that the loss function may apparently increase when an error occurs to a prediction result of the impervious layer class. By adjusting the loss function, the prediction result can be corrected rapidly. Therefore, targets belonging to the impervious layer class may be effectively prevented from missing in detection, and the efficiency and accuracy of training are thus improved.

Action 2, model pruning is performed in a complex HR-Net by means of a geometric median.

In some embodiments, the HR-Net trained in the first action is used as the initial network 303, and convolution kernels in a specific convolution layer in each block of the initial network 303 are pruned to obtain a first neural network 304. For example, all the convolution layers in each block, except a layer previous to layer where images with different resolutions are combined, are pruned by a proportion of 35% to 45%, for example, pruned by a proportion of 40%.

Firstly, for each convolution kernel in each layer, a sum of 2-norms each between the convolution kernel and a respective one of the other convolution kernels in the same layer are determined. The sums are arranged in a small-to-large order, and all convolution kernel parameters corresponding to the first 40% of the sums are set to be 0. A smaller 2-norm sum indicates that a corresponding convolution kernel is more similar to the other convolution kernels, namely the corresponding convolution kernel may be represented by the other convolution kernels. The performance of the whole network may not be greatly influenced even if the corresponding convolution kernel is deleted.

Then, the parameters of the pruned network are assigned to the initial network 303, and the network 304 including the parameters of the pruned network is continued to be trained. For example, the initial network contains 10 parameters. Firstly, the input image is processed by use of the 10 parameters in the initial network, and four smaller parameters among the 10 parameters are set to be 0. Then, the network is continued to be trained by use of the 10 parameters including the four parameters with a numeric value 0, and new results (no more 0) are obtained for the four parameters that were 0 before. After the training, four smaller parameters among the 10 parameters in the trained network are set to be 0 again. The previous steps are repeated. After such sequential iteration, the four parameters with the value 0 in a last training result are finally deleted to obtain a network containing 6 parameters, and the pruned network 304 is saved. The efficiency of making a land cover map is improved.

As such, for high efficiency required by making a large-scale land cover map, the convolution kernels of the second neural network with many parameters are pruned and compressed, so that time for predicting classes of pixels in the sample image by the first neural network is reduced. Furthermore, multiple prediction tasks may be allocated to a single Graphics Processing Unit (GPU) card, and the efficiency of making the large-scale land cover map is effectively improved.

Action 3, a probability map corresponding to an impervious layer class is processed by region adaptive histogram equalization.

In some embodiments, as illustrated in FIG. 3, after the sample images 301 and 302 pass through the pruned network 304, a probability map corresponding to each class in a preset land cover class library is obtained. For example, firstly, 10 land cover classes are set to obtain the preset land cover class library. In such case, after the input sample images 301 and 302 pass through the pruned network 304, probability maps corresponding to the 10 classes are obtained, for example, a probability map 305 corresponding to a cultivated land class. Region adaptive histogram equalization is performed on the probability map 306 (corresponding to the first target result in the above embodiment) corresponding to the impervious layer class to obtain an enhanced probability map 307 (corresponding to the second target result in the above embodiment). Probability maps corresponding to the other classes except the impervious layer class, for example, a probability map 308 of an ice-snow class, are not processed. Based on this, the probability maps corresponding to the 10 classes are determined. Then, a maximum probability among probabilities of each pixel corresponding to the 10 classes is determined according to the probability maps corresponding to the 10 classes, and a target class corresponding to the maximum probability is determined as a class that the pixel belongs to. In such a manner, the target class that each pixel belongs to is obtained. Finally, a land cover map 309 is created based on the target class that each pixel belongs to.

For the impervious layer class, by analyzing the probability map of prediction results of the class, it is found that response degrees of the class are different in different regions. For example, a response in a dense region (for example, an urban area) of the impervious layer class is stronger, and a response in a sparse region (for example, a suburb) of the impervious layer class i is weaker and is not sufficiently distinguishable from a response of another class, resulting in that road target prediction results are discontinuous, buildings in urban areas are connected into one piece without details and the like. Therefore, probability results are processed locally, and different histogram equalization is performed for different regions to enhance the distinguishability between responses. For example, a size of a region block in a large-scale high-resolution remote sensing image may be set to 512*512, to improve the probability of recognizing the impervious layer class, thereby recognizing the impervious layer class more clearly. In some embodiments, in suburb where the impervious layer class is sparse, all around roads are farmlands and road targets are relatively narrow, so that it is difficult to recognize the roads. In a probability map for road recognition, a probability value of the farmland around the road is 0.4, and a probability of the road is 0.3. After region adaptive histogram equalization is performed on the probability map, a region that may be recognized as a road may be enhanced, the probability of the road is increased to 0.7, and the probability of the farmland around is still 0.4. In such a manner, the accuracy of recognizing the impervious layer class is improved. Moreover, region adaptive histogram equalization is simple, clear, rapid and effective, and no additional calculation overhead is brought.

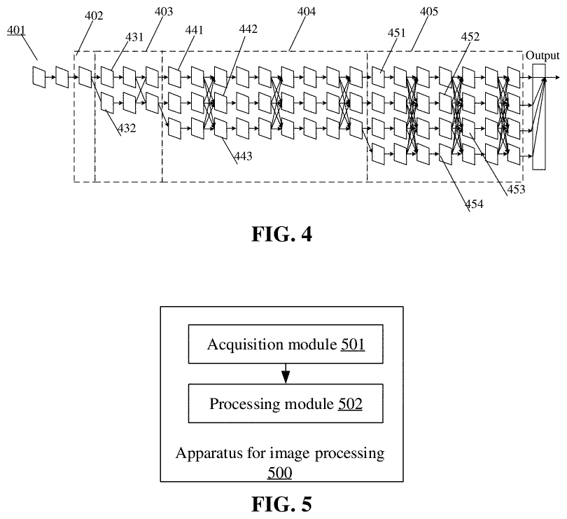

An apparatus for image processing is provided in the embodiments of the disclosure. FIG. 5 illustrates a structural diagram of composition of an apparatus for image processing according to embodiments of the disclosure. As illustrated in FIG. 5, the apparatus 500 includes an acquisition module 501 and a processing module 502.

The acquisition module 501 is configured to acquire a first target result from a classification result set. The classification result set is obtained by a first neural network through processing a to-be-processed image, and includes classification results each corresponding to a respective one of a plurality of land cover classes.

The processing module 502 is configured to adjust the first target result to obtain a second target result.

The processing module 502 is further configured to obtain an image recognition result according to the second target result and the classification results in the classification result set except the first target result.

In the above apparatus, the to-be-processed image is a sample image, and the sample image includes an image obtained by concatenating at least two sample sub-images, each being acquired at a respective different time node.

In the above apparatus, the processing module 502 is further configured to obtain the first neural network according to a trained second neural network. A complexity of the second neural network is higher than a complexity of the first neural network. Correspondingly, the acquisition module is further configured to process the to-be-processed image by a first convolution layer in the first neural network to obtain a first intermediate result; and process the first intermediate result and the to-be-processed image by a second convolution layer in the first neural network to obtain a second intermediate result, and process the second intermediate result and the to-be-processed image as input of a next convolution layer in the first neural network until the classification result set is obtained

In the above apparatus, the processing module 502 includes a pruning module, configured to prune a network layer (for example, a convolution kernel of a convolution layer) in the second neural network to obtain the first neural network with a simpler network architecture (for example, fewer convolution kernels in convolution layers).

In the above apparatus, the deletion module includes a first determination unit, a second determination unit and a first adjustment unit. The first determination unit is configured to determine a set of 2-norm sums corresponding to convolution kernels in at least one layer in the second neural network. A 2-norm sum corresponding to each of the convolution kernels includes a sum of 2-norms, each between a convolution kernel parameter of the convolution kernel and a convolution kernel parameter of a respective another convolution kernel, and the respective another convolution kernel is in a same layer in the second neural network as the convolution kernel. The second determination unit, is configured to determine, in the set of 2-norm sums determined by the first determination unit, a target 2-norm sum smaller than a preset threshold. The first adjustment unit, configured to adjust a convolution kernel parameter of a convolution kernel corresponding to the target 2-norm sum determined by the second determination unit, to obtain the first neural network.

In the apparatus, the acquisition module 501 includes a first classification submodule and a first determination submodule. The first classification submodule is configured to classify, by the first neural network, land cover in the to-be-processed image to obtain the classification result set. The classification result set includes probability maps each corresponding to a respective one of the plurality of land cover classes. The first determination submodule is configured to determine a probability map corresponding to a specific land cover class, in the classification result set determined by the first classification submodule, to be the first target result. The specific land cover class includes a land cover class corresponding to picture content of which class recognizability is lower than a recognizability threshold.

In the above apparatus, the first classification submodule is further configured to: perform, by the first neural network, instance normalization (IN) and batch normalization (BN) successively on the to-be-processed image to obtain a candidate image, and classify land cover corresponding to picture content in the candidate image to obtain the probability maps corresponding to the plurality of land cover classes.

In the above apparatus, the first classification submodule includes: a second determination unit and a third determination unit. The second determination unit is configured to determine, by the first neural network, probability sets corresponding to all pixel in the candidate image according to the plurality of land cover classes in a preset land cover class library. A probability set corresponding to each pixel includes probabilities that the pixel belongs to the plurality of land cover classes respectively. The third determination unit is configured to obtain the probability maps corresponding to the plurality of land cover classes according to the probability sets obtained by the second determination unit.

In the above apparatus, the processing module 502 is further configured to: adjust a recognition parameter of the first target result to obtain the second target result. Recognizability of the second target result is higher than recognizability of the first target result, and the recognition parameter influences the recognizability of the first target result.

In the above apparatus, the processing module 502 includes: a second determination submodule and a third determination submodule. The second determination submodule is configured to determine a target classification result corresponding to each pixel in the to-be-processed image according to the second target result and the classification results in the classification result set obtained by the first classification submodule except the first target result. The third determination submodule is configured to obtain the image recognition result according to a land cover class corresponding to the target classification result determined by the second determination submodule.

It is to be noted that description about the above apparatus embodiment are similar to description about the method embodiment, beneficial effects similar to those of the method embodiment are achieved by the apparatus embodiment. Technical details that are not disclosed in the apparatus embodiment of the disclosure may be understood with reference to the description about the method embodiment of the disclosure.

It is to be noted that, in the embodiments of the disclosure, when implemented in form of software function module and sold or used as an independent product, the method for image processing may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a terminal, a server, etc.) to execute all or part of the method in each embodiment of the disclosure. The storage medium includes various mediums capable of storing program codes such as a USB flash disk, a mobile hard disk, a Read Only Memory (ROM), a magnetic disk or an optical disk. Therefore, the embodiments of the disclosure are not limited to any specific combination of hardware and software.

Correspondingly, the embodiments of the disclosure also provide a computer program product, which includes computer-executable instructions configured to implement the actions of the method for image processing provided in the embodiments of the disclosure.

Correspondingly, the embodiments of the disclosure also provide a computer storage medium having stored thereon computer-executable instructions configured to implement the actions of the method for image processing provided in the abovementioned embodiment.

The embodiments of the disclosure also provide a computer program, which includes computer-readable code that when running in a device, causes a processor in the device to execute instructions configured to implement the method for image processing.

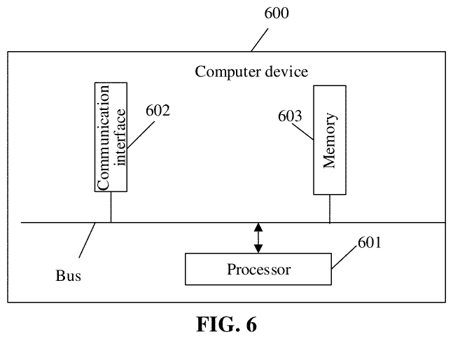

Correspondingly, the embodiments of the disclosure also provide a computer device. FIG. 6 is a structural diagram of a computer device according to embodiments of the disclosure. As illustrated in FIG. 6, the device 600 includes a processor 601, a communication interface 602 and a memory 603. The communication interface 602 is configured to implement connections and communications between these components. The communication interface 602 may include a standard wired interface and wireless interface. The processor 601 is configured to execute an image processing program in the memory to implement the actions of the method for image processing provided in the abovementioned embodiment.

The above description about the embodiments focus on differences between embodiments and the same or similar parts may refer to each other and will not be described herein for simplicity.

In the disclosure, term “and/or” is only an association relationship describing associated objects and represents that three relationships may exist. For example, A and/or B may represent three situations: i.e., independent existence of A, existence of both A and B, and independent existence of B.

The above description about the computer device and storage medium embodiments is similar to description about the method embodiments, and beneficial effects similar to those of the method embodiments are achieved. Technical details that are disclosed in the computer device and storage medium embodiments of the disclosure may be understood with reference to the description about the method embodiments of the disclosure.

It is to be understood that “some embodiments” and “an embodiment” mentioned throughout the specification mean that specific features, structures or characteristics related to the embodiment is included in at least one embodiment of the disclosure. Therefore, “in some embodiment” or “in an embodiment” appearing at any place throughout specification does not always refer to the same embodiment. In addition, these specific features, structures or characteristics may be combined in one or more embodiments in any proper manner It is to be understood that, in various embodiments of the disclosure, a magnitude of a serial number in each process does not mean an execution sequence, and the execution sequence of procedures should be determined by their functions and internal logics. No limitation shall be formed to an implementation process of the embodiments of the disclosure. The serials numbers in the embodiments of the disclosure do not represent superiority-inferiority of the embodiments but is only used for description.

It is to be noted that terms “include” and “contain” or any other variant thereof are intended to cover nonexclusive inclusions herein, so that a process, method, object or device including a series of elements not only includes those elements but also includes other elements which are not clearly listed or further includes elements intrinsic to the process, the method, the object or the device. Without more limitations, an element defined by the phrase “including a/an . . . ” does not exclude existence of the same other elements in a process, method, object or device including the element.

In some embodiments provided in the disclosure, it is to be understood that the disclosed device and method may be implemented in another manner The device embodiment described above is only schematic, and for example, division of the units is only logic function division, and other division manners may be employed during practical implementation. For example, multiple units or components may be combined or integrated into another system, or some characteristics may be neglected or not executed. In addition, coupling or direct coupling or communication connection between displayed or discussed components may be indirect coupling or communication connection, implemented through some interfaces, of the device or the units, and may be electrical, mechanical or in other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments of the disclosure.

In addition, functional units in various embodiments of the disclosure may be integrated into a processing unit. Each unit may also serve as an independent unit and two or more than two units may also be integrated into one unit. The integrated unit may be implemented in a hardware form and may also be implemented in form of hardware and software functional unit.

Those of ordinary skill in the art should know that all or some or the actions of the method embodiment may be implemented by related hardware instructed through a program. The program may be stored in a computer-readable storage medium, and the program is executed to implement the actions of the method embodiment. The storage medium includes: various mediums capable of storing program code such as a mobile storage device, a ROM, a magnetic disk or a compact disc.

Alternatively, when implemented in form of software functional module and sold or used as an independent product, the integrated unit of the disclosure may also be stored in a computer-readable storage medium. Based on such an understanding, the technical solutions of the embodiments of the disclosure substantially or parts making contributions to the conventional art may be embodied in form of software product, and the computer software product is stored in a storage medium, including a plurality of instructions configured to enable a computer device (which may be a personal computer, a server, a network device or the like) to execute all or part of the method in each embodiment of the disclosure. The storage medium includes various media capable of storing program codes such as a mobile hard disk, a ROM, a magnetic disk or a compact disc.

The above is only the detailed description of the disclosure and is not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for image processing, comprising:
acquiring a first target result from a classification result set, wherein the classification result set is obtained by a first neural network through processing a to-be-processed image, and comprises classification results each corresponding to a respective one of a plurality of land cover classes;
adjusting the first target result to obtain a second target result; and
obtaining an image recognition result according to the second target result and the classification results in the classification result set except the first target result.

2. The method of claim 1, wherein the to-be-processed image is a sample image, and the sample image comprises an image obtained by concatenating at least two sample sub-images, each being acquired at a respective different time node.

3. The method of claim 1, further comprising:
obtaining the first neural network according to a trained second neural network, wherein a complexity of the trained second neural network is higher than a complexity of the first neural network; and
wherein, before acquiring the first target result, the method further comprises:
processing the to-be-processed image by a first convolution layer in the first neural network to obtain a first intermediate result; and
processing the first intermediate result and the to-be-processed image by a second convolution layer in the first neural network to obtain a second intermediate result, and processing the second intermediate result and the to-be-processed image as input of a next convolution layer in the first neural network until the classification result set is obtained.

4. The method of claim 3, wherein obtaining the first neural network according to the trained second neural network comprises:
pruning a network layer in the trained second neural network to obtain the first neural network.

5. The method of claim 4, wherein pruning the network layer in the trained second neural network to obtain the first neural network comprises:
determining a set of 2-norm sums corresponding to convolution kernels in at least one layer in the trained second neural network, wherein a 2-norm sum corresponding to each of the convolution kernels comprises a sum of 2-norms, each between a convolution kernel parameter of the convolution kernel and a convolution kernel parameter of a respective another convolution kernel, and the respective another convolution kernel is in a same layer in the trained second neural network as the convolution kernel;
determining, in the set of 2-norm sums, a target 2-norm sum smaller than a preset threshold; and
adjusting a convolution kernel parameter of a convolution kernel corresponding to the target 2-norm sum to obtain the first neural network.

6. The method of claim 1, wherein acquiring the first target result from the classification result set, wherein the classification result set is obtained by the first neural network through processing the to-be-processed image comprises:
classifying, by the first neural network, land cover in the to-be-processed image to obtain the classification result set, wherein the classification result set comprises probability maps each corresponding to a respective one of the plurality of land cover classes; and
determining a probability map corresponding to a specific land cover class among the probability maps corresponding to the plurality of land cover classes to be the first target result, wherein the specific land cover class comprises a land cover class corresponding to picture content of which class recognizability is lower than a recognizability threshold.

7. The method of claim 1, wherein adjusting the first target result to obtain the second target result comprises:
adjusting a recognition parameter of the first target result to obtain the second target result, wherein recognizability of the second target result is higher than recognizability of the first target result, and the recognition parameter influences the recognizability of the first target result.

8. The method of claim 6, wherein classifying, by the first neural network, the land cover in the to-be-processed image to obtain the classification result set comprises:
performing, by the first neural network, instance normalization (IN) and batch normalization (BN) successively on the to-be-processed image to obtain a candidate image, and classifying land cover corresponding to picture content in the candidate image to obtain the probability maps corresponding to the plurality of land cover classes.

9. The method of claim 6, wherein classifying, by the first neural network, the land cover in the to-be-processed image to obtain the classification result set comprises:
determining, by the first neural network, probability sets corresponding to all pixels in a candidate image according to the plurality of land cover classes in a preset land cover class library, wherein a probability set corresponding to each pixel comprises probabilities that the pixel belongs to the plurality of land cover classes respectively; and
obtaining the probability maps corresponding to the plurality of land cover classes according to the probability sets corresponding to all the pixels in the candidate image.

10. The method of claim 1, wherein obtaining the image recognition result according to the second target result and the classification results in the classification result set except the first target result comprises:
determining a target classification result corresponding to each pixel in the to-be-processed image according to the second target result and the classification results in the classification result set except the first target result; and
obtaining the image recognition result according to a land cover class corresponding to the target classification result.

11. A computer device, comprising a memory and a processor, wherein computer-executable instructions are stored in the memory, and the computer-executable instructions in the memory, when operated by the processor, cause the processor to
acquire a first target result from a classification result set, wherein the classification result set is obtained by a first neural network through processing a to-be-processed image, and comprises classification results each corresponding to a respective one of a plurality of land cover classes;
adjust the first target result to obtain a second target result; and
obtain an image recognition result according to the second target result and the classification results in the classification result set except the first target result.

12. The computer device of claim 11, wherein the to-be-processed image is a sample image, and the sample image comprises an image obtained by concatenating at least two sample sub-images, each being acquired at a respective different time node.

13. The computer device of claim 11, wherein the computer-executable instructions in the memory, when operated by the processor, further cause the processor to:
obtain the first neural network according to a trained second neural network, wherein a complexity of the trained second neural network is higher than a complexity of the first neural network; and
before acquiring the first target result, process the to-be-processed image by a first convolution layer in the first neural network to obtain a first intermediate result; and process the first intermediate result and the to-be-processed image by a second convolution layer in the first neural network to obtain a second intermediate result, and process the second intermediate result and the to-be-processed image as input of a next convolution layer in the first neural network until the classification result set is obtained.

14. The computer device of claim 13, wherein in obtaining the first neural network according to the trained second neural network, the computer-executable instructions in the memory, when operated by the processor, further cause the processor to:
prune a network layer in the trained second neural network to obtain the first neural network.

15. The computer device of claim 14, wherein in pruning the network layer in the trained second neural network to obtain the first neural network, the computer-executable instructions in the memory, when operated by the processor, further cause the processor to:
determine a set of 2-norm sums corresponding to convolution kernels in at least one layer in the trained second neural network, wherein a 2-norm sum corresponding to each of the convolution kernels comprises a sum of 2-norms, each between a convolution kernel parameter of the convolution kernel and a convolution kernel parameter of a respective another convolution kernel, and the respective another convolution kernel is in a same layer in the trained second neural network as the convolution kernel;
determine, in the set of 2-norm sums, a target 2-norm sum smaller than a preset threshold; and
adjust a convolution kernel parameter of a convolution kernel corresponding to the target 2-norm sum to obtain the first neural network.

16. The computer device of claim 11, wherein in acquiring the first target result from the classification result set, wherein the classification result set is obtained by the first neural network through processing the to-be-processed image, the computer-executable instructions in the memory, when operated by the processor, further cause the processor to:
classify, by the first neural network, land cover in the to-be-processed image to obtain the classification result set, wherein the classification result set comprises probability maps each corresponding to a respective one of the plurality of land cover classes; and
determine a probability map corresponding to a specific land cover class, in the obtained classification result set, to be the first target result, wherein the specific land cover class comprises a land cover class corresponding to picture content of which class recognizability is lower than a recognizability threshold.

17. The computer device of claim 16, wherein in classifying, by the first neural network, the land cover in the to-be-processed image to obtain the classification result set, the computer-executable instructions in the memory, when operated by the processor, further cause the processor to:
perform, by the first neural network, instance normalization (IN) and batch normalization (BN) successively on the to-be-processed image to obtain a candidate image, and classifying land cover corresponding to picture content in the candidate image to obtain the probability maps corresponding to the plurality of land cover classes; or
determine, by the first neural network, probability sets corresponding to all pixels in the candidate image according to the plurality of land cover classes in a preset land cover class library, wherein a probability set corresponding to each pixel comprises probabilities that the pixel belongs to the plurality of land cover classes respectively; and obtain the probability maps corresponding to the plurality of land cover classes according to the probability sets corresponding to all the pixels in the candidate image.

18. The computer device of claim 11, wherein in adjusting the first target result to obtain the second target result, the computer-executable instructions in the memory, when operated by the processor, further cause the processor to:
adjust a recognition parameter of the first target result to obtain the second target result, wherein recognizability of the second target result is higher than recognizability of the first target result, and the recognition parameter influences the recognizability of the first target result.

19. The computer device of claim 11, wherein in obtaining the image recognition result according to the second target result and the classification results in the classification result set except the first target result, the computer-executable instructions in the memory, when operated by the processor, further cause the processor to:
determine a target classification result corresponding to each pixel in the to-be-processed image according to the second target result and the classification results in the obtained classification result set except the first target result; and
obtain the image recognition result according to a land cover class corresponding to the target classification result.

20. A non-transitory computer storage medium having stored thereon computer-executable instructions that, when being executed, implement following actions:
acquiring a first target result from a classification result set, wherein the classification result set is obtained by a first neural network through processing a to-be-processed image, and comprises classification results each corresponding to a respective one of a plurality of land cover classes;
adjusting the first target result to obtain a second target result; and
obtaining an image recognition result according to the second target result and the classification results in the classification result set except the first target result.
